(19) United States
(12) Patent Application Publication
(10) Pub. No.: US 2006/0040648 A1
(43) Pub. Date: Feb. 23, 2006

(54) Management of service products in a network

(76) Inventors: Tuija Vikman, Lempaala (FI); Mikko Ruhanen, Tampere (FI); Ulla Koivukoski, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/530,702

(22) PCT Filed: Oct. 9, 2003
(86) PCT No.: PCT/FI03/00747

§ 371 Date: Apr. 8, 2005

(30) Foreign Application Priority Data
Oct. 11, 2002 (FI) 20021815

(51) Int. Cl. H04Q 7/38

(52) U.S. Cl. 455/414.1

(57) ABSTRACT

A service planning unit for planning high-level service products to subscribers in a telecommunication network. The service planning unit comprises or is closely connected to 1) a service topology database for storage and on-line distribution of information on service components which are operable to act as components for building high-level services in a network; 2) a service simulation and testing section for providing functions relating to verification of service products; 3) a service deployment section for deploying services in the telecommunication network; 4) a service assurance section for monitoring and reporting of the service products; and 5) a usage reporting section for processing reports on the service products' performance and usage.

### BACKGROUND OF THE INVENTION

The invention relates to methods and equipment for managing network service products. Computer models exist for managing telecommunication networks and basic bearer services. For example, PCT application WO 01/54350 discloses a system and a method for modelling communication networks.

Prior art modelling systems are somewhat restricted, however. From an end user's point of view, a service product may appear homogenous or monolithic. That is, a mobile subscriber may receive a personalized weather or stock market report without thinking or knowing that the service product consists of several very different components, namely a network service, an application logic and a content. The content is the updated report. The application logic is the logic that determines the content. The network service provides the underlying platform for delivering the content to the subscriber. Typically, a different organization is responsible for each component. A network operator provides the network service. A content provider provides the content, but typically does not know how to deliver the content to subscribers in various networks. An application designer integrates the content with the network but does not know all the details of the content or the network(s).

Thus a problem of the prior art modelling systems is that they do not cross the boundaries between organizations (network operator, application designer, content provider) and each organization only models its own part of the whole.

### BRIEF DESCRIPTION OF THE INVENTION

An object of the present invention is to provide a method and an apparatus for implementing the method so as to alleviate the above disadvantages. The object of the invention is achieved by the methods and equipment which are characterized by what is stated in the independent claims. Preferred embodiments of the invention are disclosed in the dependent claims.

The invention is based on the idea of modelling network services across the traditional inter-organization boundaries. In other words, a common model models the network services that are provided by the network operator, applications that are typically provided by application developers and content that is typically provided by content providers. Each of the three parts of the whole, ie network services, applications and content, are modelled as components. The components have well-defined and published interfaces. A benefit of the common model modelling all parts of the whole is a better understanding of the whole. Further, various interactions between components in different parts of the whole (such as applications and network services or applications and content) become more readily visible. An advantage of using components with well-defined interfaces is that the components can be reused to create additional services.

Prior art modelling systems do not have integrated basic network services or value-added services (applications) because the network operators and application developers have each provided their own models. The inventive technique enables modelling basic network services and value-added services in a common model which helps to integrate the value-added services with the underlying network-level services. In addition, the inventive model at least provides well-defined interfaces for content components and, preferably, models the content components in the same common model. A benefit of the common model modelling basic network services and value-added services is that content providers can use the common model to develop and test content components without access to real network resources.

Some essential terms of the invention will be described first. A software component, as used in contexts like “network service component”, “application component” and “content component”, means a software collection with one or more well-defined interfaces. As used in this context, a well-defined interface means an interface that adheres to certain common rules, whereby each component can be referred to in a systematic manner. Well-defined interfaces can be open or proprietary (vendor-specific).

A network service component is an abstraction that defines a network service (as distinct from higher-level services, such as weather forecasts). The application component provides value-added services, that is, services beyond basis network or bearer services. The content component is what the subscriber is really interested in, such as a weather or stock market report, a piece of music or video, etc.

An aspect of the invention is a method for modelling a high-level service to be provided via a telecommunication network, the method comprising:

modelling the high-level service by a software component model comprising at least one of each of the following:
a network service component
an application component; and
a content component;

the software component model further comprising relations between said components.

Another aspect of the invention is a service topology database for storing and distributing information on service components which are operable to act as components for building high-level services in a network, the service topology database comprising:
a) network service component data comprising for each of several network service components:
identification information;
status information;
usage information; and
parameter information indicating how the component can be parameterized to suit different service products;
b) relationships between service components, the relationships indicating restrictions related to use of components for a service product;
c) service product data comprising for each of several service products:
identification information;
status information;
usage information; and
information on network service components used for the service product;
parameter information on the used service components;
service component level information comprising at least tariff information; and
deployment rules determining how the service product is deployable in the network.

Yet another aspect of the invention is a service planning unit for planning high-level service products to subscribers in a telecommunication network, wherein the service planning unit comprises or is closely connected to:

a service topology database for storage and on-line distribution of information on service components which are operable to act as components for building high-level services in a network;

a service simulation and testing section for providing functions relating to verification of service products;

a service deployment section for deploying services in the telecommunication network;

a service assurance section for monitoring and reporting of the service products; and

a usage reporting section for processing reports on the service products' performance and usage.

As used herein, the expression “closely connected” means under common administration and having on-line access to each others' data.

### BRIEF DESCRIPTION OF THE DRAWINGS

In the following the invention will be described in greater detail by means of preferred embodiments with reference to the attached drawings, in which:

FIG. 1 illustrates a basic concept of the service product modelling according to the invention;

FIG. 2 illustrates the various stages in the development of service components;

FIG. 3 illustrates an exemplary network arrangement in which the invention can be used;

FIG. 4 illustrates development of application components;

FIG. 5 illustrates testing of service components;

FIG. 6 illustrates deployment of service components;

FIG. 7 illustrates development of service products; and

FIG. 8 illustrates deployment of service products;

FIG. 9 shows the composition of the end-user service in more detail than FIG. 1 does; and

FIG. 10 illustrates how service components can be stored in repositories that enable re-using of the components.

### DETAILED DESCRIPTION OF THE INVENTION

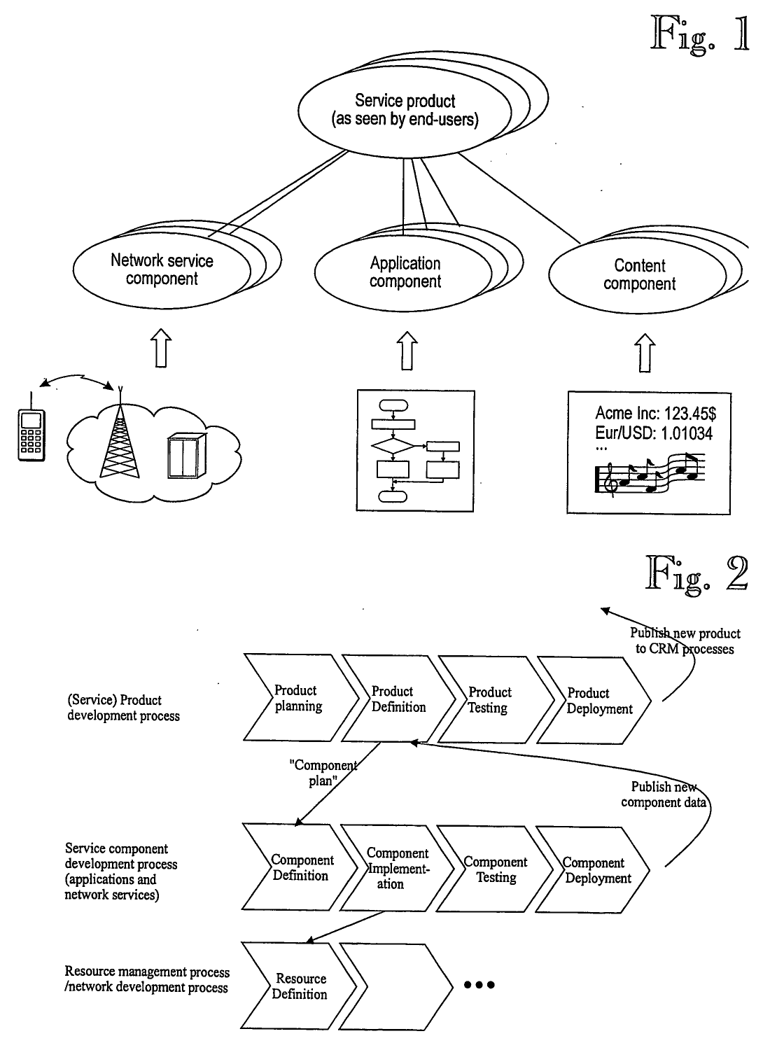

FIG. 1 illustrates a basic concept of the service product modelling according to the invention. A service product model according to the invention comprises at least the following types of components: 1) network service component, 2) application component and 3) content component. A gross analogy to goods delivery systems is that the network service component corresponds to transport infrastructure (roads, railways, vehicles, etc.) The application component corresponds to transportation logistics. The content component corresponds to the actual goods being delivered. By way of example, the bottom section of FIG. 1 shows iconic representations of the meaning of network service, application and content.

A network service component is an abstraction that defines a network service (as distinct from higher-level services, such as weather forecasts). The network service is defined by a set of parameters describing, for example, the quality, capacity and security of the network service. The network service component helps to hide the complexity of the network from the service management. By way of example, the parameters comprise identity data and component data. The identity data typically comprises 1) name, 2) status and 3) location information. The name is the component's identifier. The status information indicates active or inactive status and, optionally, version information unless the version is indicated in the identity data. The location indicates where the component is located. The component data may comprise 1) deployment rules, 2) quality policy rules, 3) security rules, etc.

The application component provides value-added services, that is, services beyond basis network or bearer services. For example, the value-added services are used by MMS (multimedia messaging specifications), IMS (IP Multimedia Subsystem) and MCD (Mobile Content Delivery) solutions. The application component comprises 1) application identity data, 2) the application logic, 3) application component data and 4) metadata. The application identity data typically comprises information similar to identity data of the network service, ie, name, status and location information. The application logic is the engine that drives the application. Typically, the application logic is implemented in a high-level language, such as Java. The application logic can also be based on more or less fixed network element functions, such as call control functions. The application component data comprises configuration parameters and application data. The metadata comprises data about elements, including their descriptions, ownership, access paths, access rights and data volatility. The metadata comprises 1) application metadata, ie, parameters used in the application, 2) content metadata, ie, content component parameters used in the content component, and 3) verification information which is used when the data is set up, for example, in the service provisioning system.

The content component is what the subscriber is really interested in. The content component comprises 1) content component identity data and 2) content component data. The content component identity data typically comprises information similar to identity data of the network service, ie, name, status and location information. The content component data comprises 1) configuration parameters and 2) content data.

In addition to the three kinds of components (network service, application, content), the model according to the invention comprises the relationships between the components. In the example shown in FIG. 1, the service product under study (or its model) comprises two network service components, three application components and one content component.

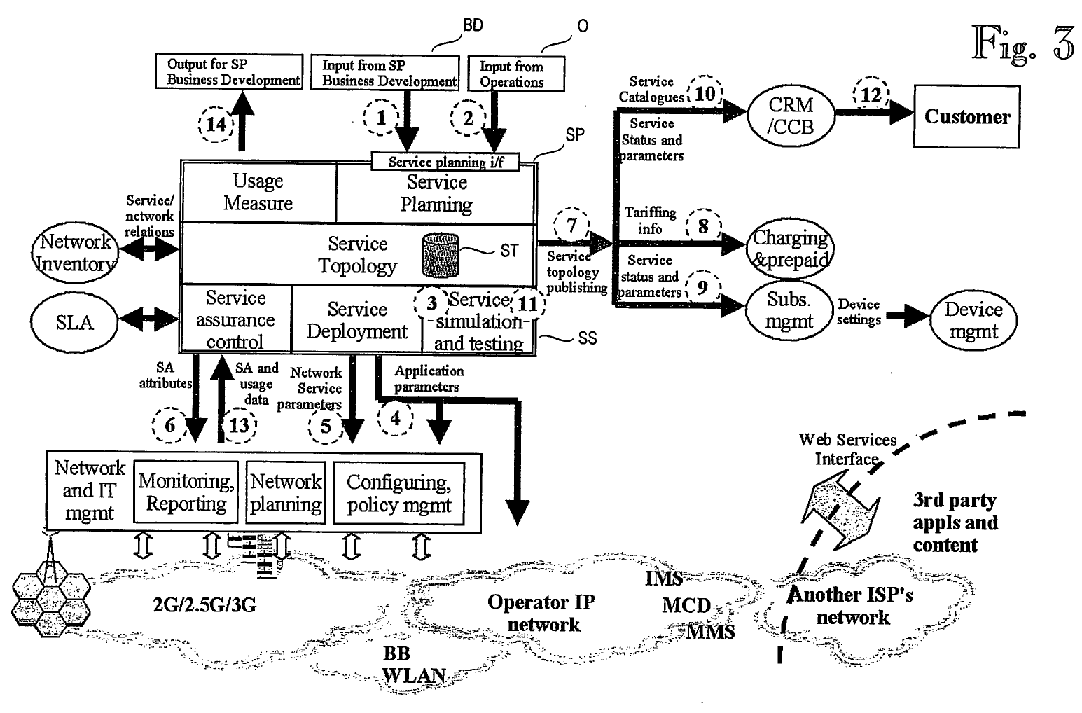

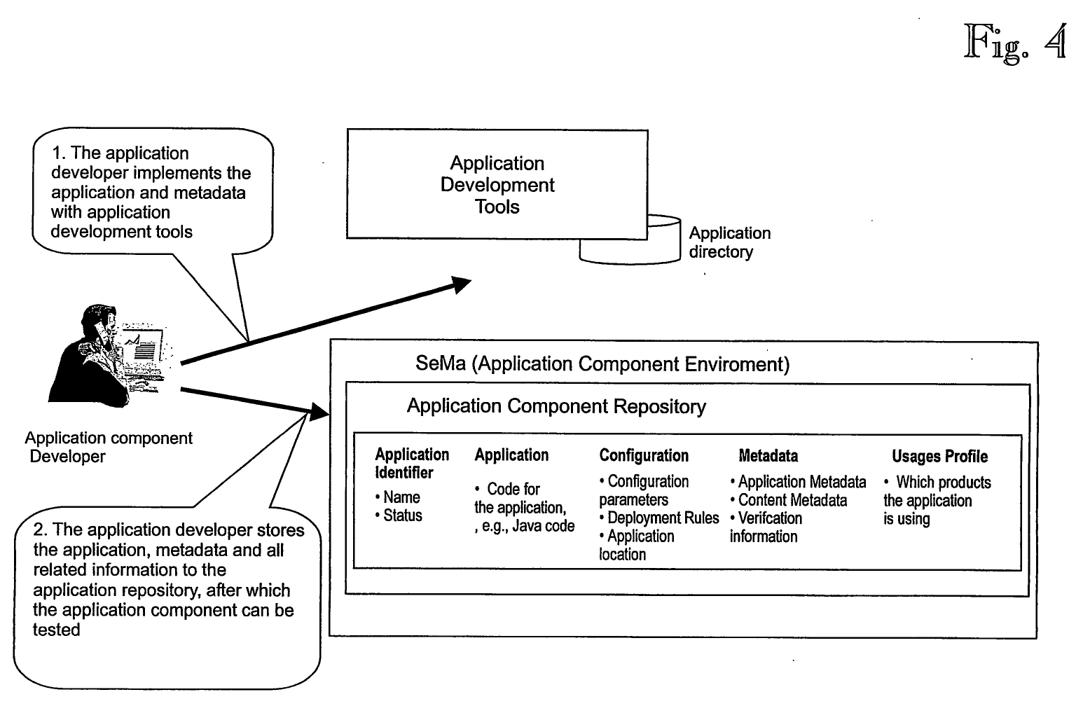

FIG. 2 presents an overall view of the various stages in the development of service components. The various stages will be further illustrated in connection with FIGS. 4 through 8.

FIG. 3 illustrates an exemplary network arrangement in which the invention can be used. In the example described herein, service management is divided into several functional blocks: service topology, service planning, service simulation and testing, service deployment, service assurance control, and service usage measuring. Reference numerals 1 to 14 depict actions needed to develop and provide service products.

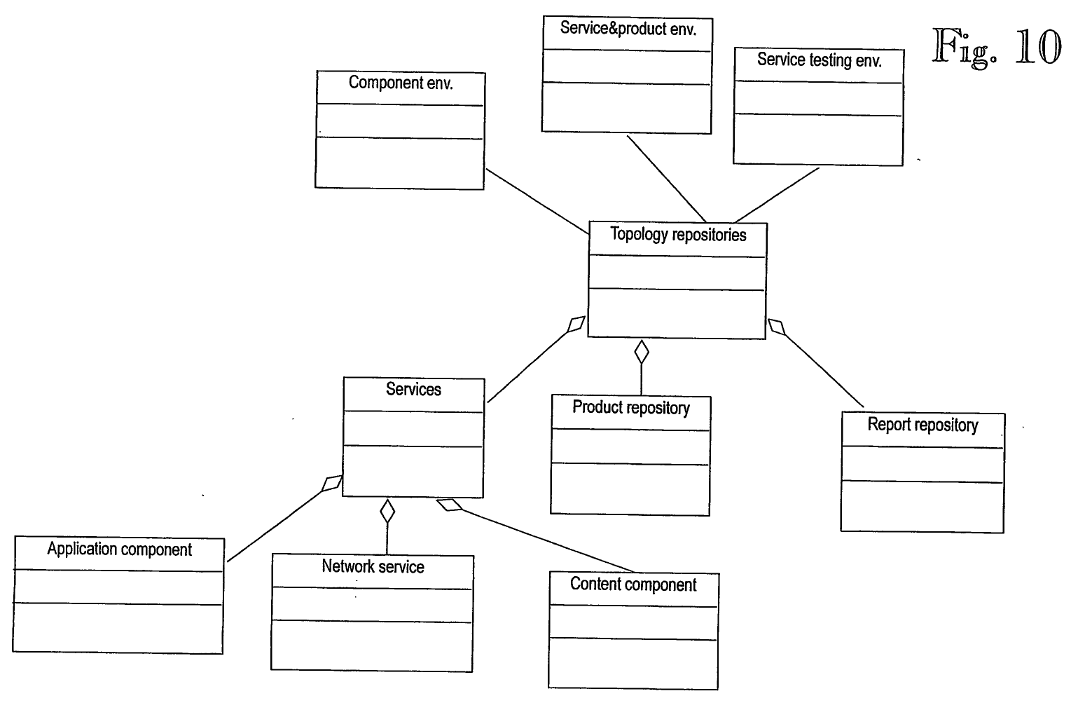

The service topology database ST is a central element of the service management model. The service topology database ST contains definitions of each service product, both from the point of view of business development and implementation/operations. Service topology is then available, in an on-line form, for all the entities in the arrangement shown in FIG. 3. The service topology database ST will be further illustrated in connection with FIG. 10.

Thus an aspect of the invention is a service topology database for storing and distributing information on service components which are operable to act as components for building high-level services in a network, the service topology database comprising:
a) network service component data comprising for each of several network service components:
identification information,
status information,
usage information, and
parameter information indicating how the component can be parameterized to suit different service products,
b) relationships between service components, the relationships indicating restrictions related to use of components for a service product,
c) service product data comprising for each of several service products:
identification information,
status information,
usage information, and
information on network service components used for the service product,
parameter information on the used service components,
service component level information comprising tariff information and, optionally, product launch and/or business target information, etc.
deployment rules determining how the service product is deployable in the network.

A service planning section SP provides functions for defining service products to the service topology through a service planning interface. The service planning section SP provides a generic extensible interface that can be used for defining several types of service products. The service planning interface can be divided to a business development part BD (action 1 in FIG. 3) and an operations part (action 2). The business development part accounts for the general product requirements with business significance and for all the product aspects that are visible to the end user. The operations part ◯ accounts for the technical implementation and deployment of the service product. The service planning is thus a joint effort between network development and operations.

A service simulation and testing section SS provides functions for the verification of service products. Herein, service simulation (action 3) refers to the initial verification of the service definition in the service topology, ie before the service product is deployed to the network. It may provide feedback to business development and operations to modify the service definition. After actions 1 to 3 are successfully performed, the service product is ready to be deployed to the network.

Service testing (action 11) refers to the final testing of the service product after it has been deployed either to the separate testing network or to the live network. After successful service testing the service product can be published for customers.

Service deployment can be seen as mediation between service topology and the network. Service deployment realizes the definition of the service topology as the actual network configuring tasks. That is, the service components are employed and parameterized in order to implement the service product. Service deployment includes: 1. determining the parameters of the network service components (action 5), which is typically performed by means of network management systems, and 2. determining the parameters of the application components (action 6). Service deployment may also include publishing the service topology information for various support systems (action 7) dealing with charging and prepaid services, subscription management, customer relationship management, or the like.

Service assurance control enables the monitoring and reporting of the service products, including both performance reporting and usage reporting. In the deployment phase, the assurance-related configuring is done to eg different monitoring tools in network management systems (action 6). This way, the linking of network performance can be linked to the performance of service products. After the service product is deployed and published to the users, the service-product-specific service assurance and usage data is collected from the network (action 13). Furthermore, the service assurance control interacts with the service level assurance (SLA) systems, enabling the linkage of service products with the different service level agreements. A service level agreement is an agreement between a user and a service provider, the agreement defining the service content, the responsibilities of both parties, and the metrics and related target levels for service performance.

Usage reporting supports the lifecycle management of service products by providing processed reports on the service products' performance and usage. The focus is on the information that enables assessing the profitability of the service products.

FIGS. 4 through 8 further illustrate the various stages in the development of service components. FIG. 4 illustrates development of application components. In FIGS. 4 to 8, “SeMa” means service management. In a first step, the application developer implements the application and metadata with application development tools. The application development tools can be commercial off-the-shelf software tools, such as Jbuilder. The application and metadata can be stored temporarily in the application directory, which forms a part of the tools.

In a second step, the application developer stores the application, metadata and all related information to the application repository, after which the application component can be tested. The application repository is a logical repository where the application components are stored. (A repository is a well-known concept in software component technology.)

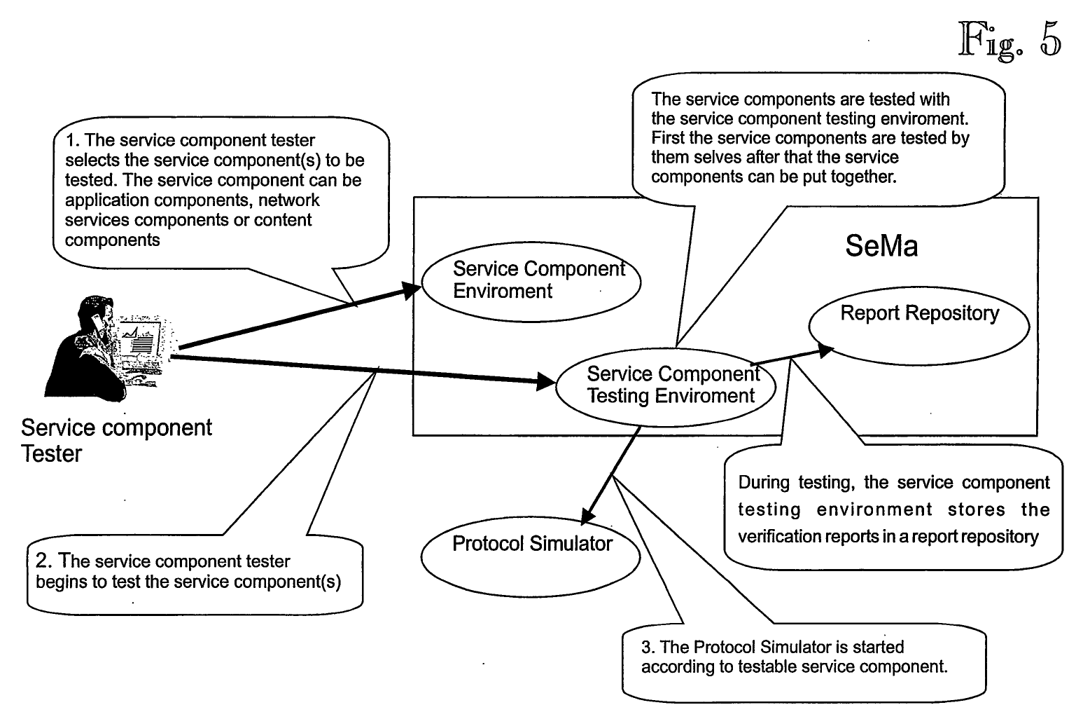

FIG. 5 illustrates testing of service components. In a first step, the service component tester selects the service component(s) to be tested. Service components can be application components, network services components or content components.

In a second step, the service component tester begins to test the service component. Next, a protocol simulator is started according to the testable service component. During the test of the service components, the service component testing environment stores the verification reports in a report repository.

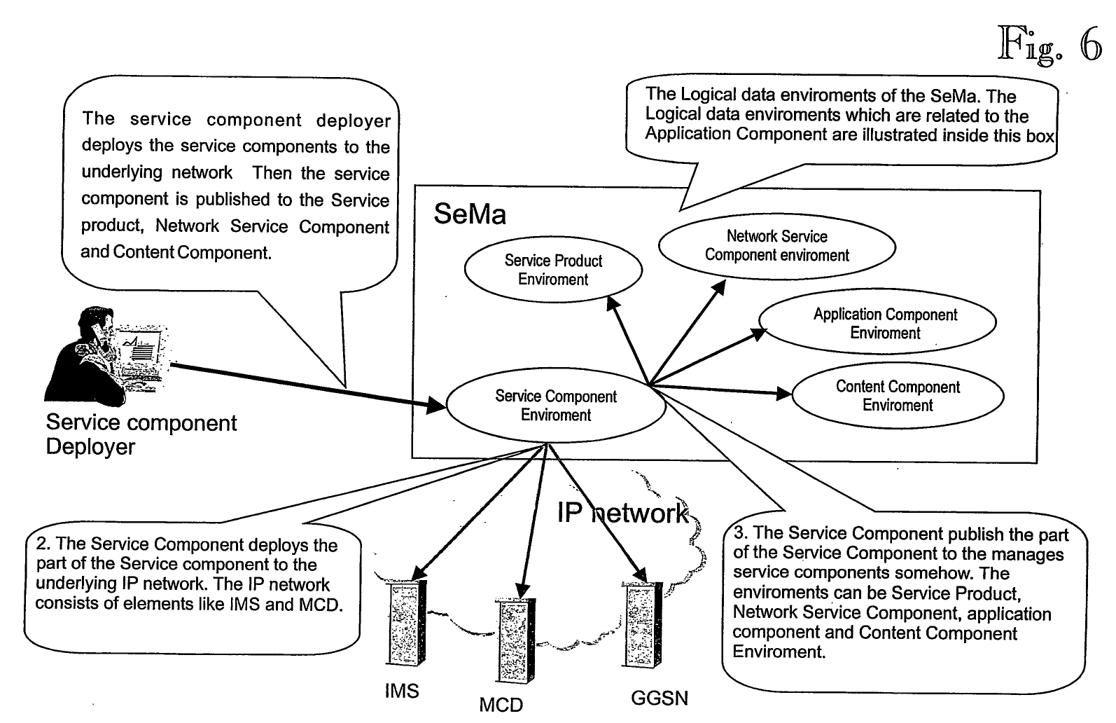

FIG. 6 illustrates deployment of service components. In a first step, the service component deployer deploys the service components to the underlying network like IMS and MCD. After the service component is deployed, the service component is published to the service product, network service component and content component. Next, the service component deployer deploys the part of the service component to the underlying IP network. The IP network consists of elements like IMS and MCD. Third, the service component deployer publishes the part of the service component to the managed service components. The environments can be service product, network service component, application component and content component environment.

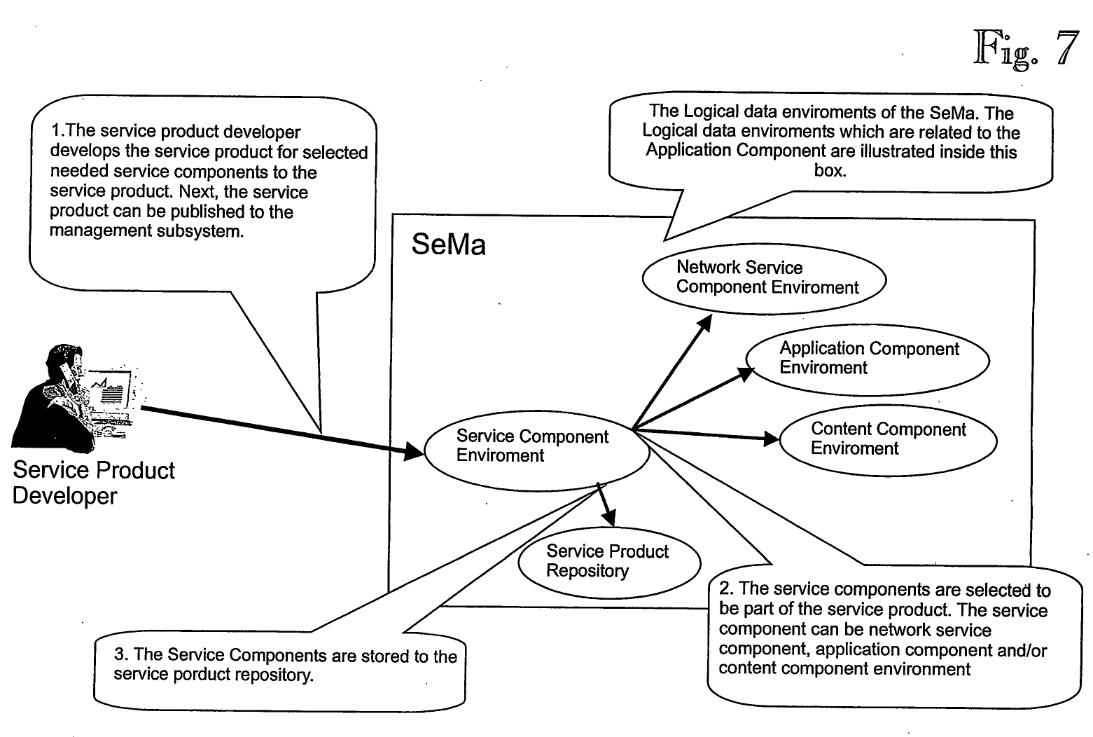

FIG. 7 illustrates development of service products. In a first step, the service product developer develops the service product for selected service components needed by the service product. After that, the service product can be published to the management subsystem. In a second step, the service components are selected to be part of the service product. The service component can be network service component, application component and/or content component environment.

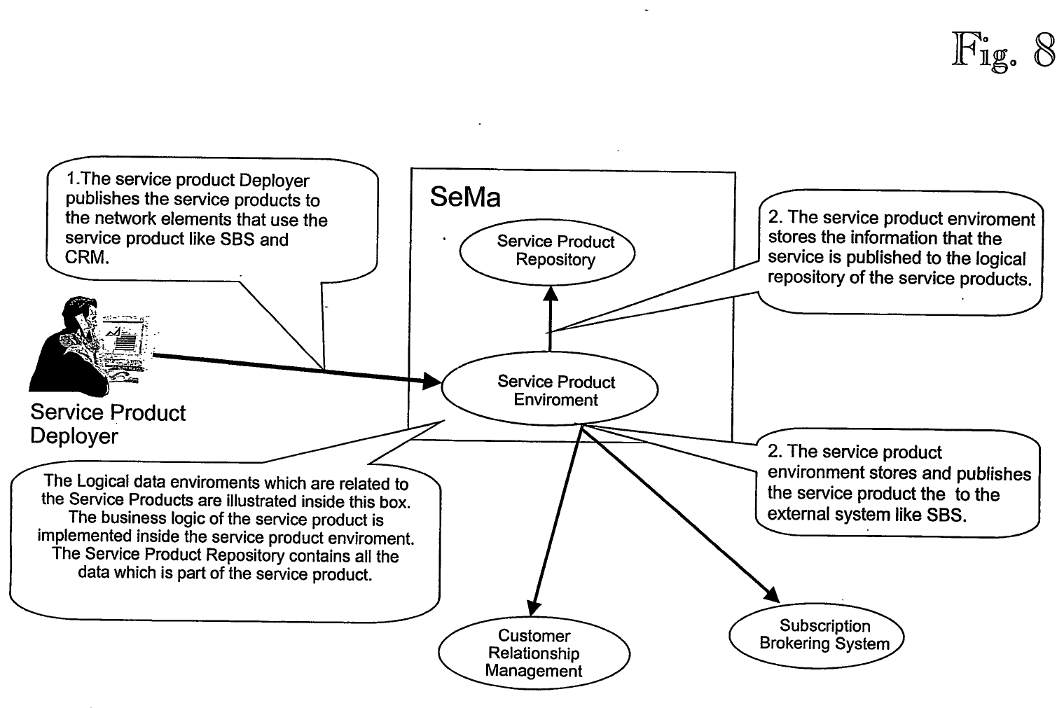

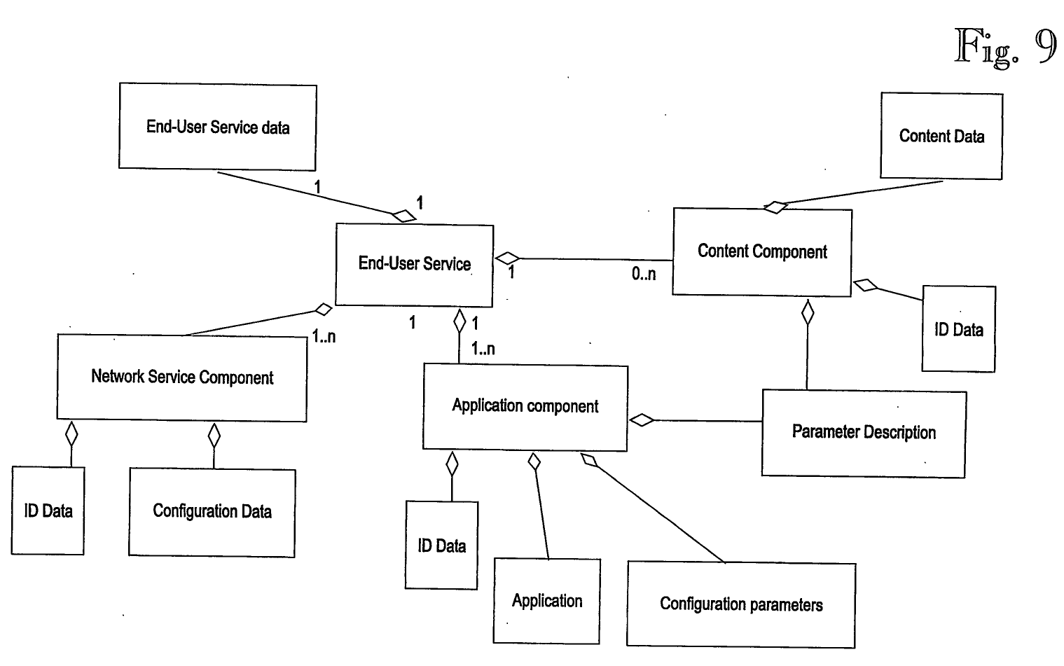

FIG. 8 illustrates deployment of service products. In a first step, the service product deployer publishes the service products to the network elements that use the service product like SBS and CRM. SBS (Subscription Brokering System) is a subscription management solution for AII-IP, 3G and GPRS and GSM network customers who need to provide end-to-end subscription management, profile brokering, more controlled and richer self-service and provisioning capabilities. Next, the service product environment stores the information that the service is published to the logical repository of the service products. In addition, the service product environment stores and publishes the service product the to external system like SBS.

FIG. 9 shows the composition of the end-user service in more detail than FIG. 1 does. An end-user service product is ultimately built from one or more network service components, one or more application components and one or more content components. In FIG. 9, the notation “1 . . . n” means one or more, but the n need not be the same number everywhere. The notation “0 . . . n” in connection with the content component means that some benefits of the invention are achieved by modelling the network service components and application components in a common model. That is, applications and basic network services can be modelled and simulated in the same model. Preferably, the model also comprises at least one content component.

FIG. 10 illustrates how service components can be stored in repositories that enable re-using of the components.

It is readily apparent to a person skilled in the art that, as the technology advances, the inventive concept can be implemented in various ways. The invention and its embodiments are not limited to the examples described above but may vary within the scope of the claims.

Acronyms (Some Are Not Official):

CRM: Customer Relations Management
IMS: IP Multimedia Subsystem
IP: Internet Protocol
MCD: Mobile Content Delivery
MMS (Multimedia Messaging Specifications)
SBS: Subscription Brokering System
SLA: Service Level Assurance

1. A method for modelling a high-level service to be provided via a telecommunication network, the method comprising:
modelling the high-level service by a software component model comprising at least one of each of the following:
a network service component
an application component; and
a content component;
the software component model further comprising relations between said components.

2. A service topology database for storing and distributing information on service components which are operable to acts as components for building high-level services in a network, the service topology database comprising:
a) network service component data comprising for each of several network service components:
identification information;
status information;
usage information; and
parameter information indicating how the component can be parameterized to suit different service products;
b) relationships between service components, the relationships indicating restrictions related to use of components for a service product;
c) service product data comprising for each of several service products:
identification information;
status information;
usage information; and
information on network service components used for the service product;
parameter information on the used service components;
service component level information comprising at least tariff information; and
deployment rules determining how the service product is deployable in the network.

3. A service planning unit for planning high-level service products to subscribers in a telecommunication network, wherein the service planning unit comprises or is closely connected to:
a service topology database for storage and on-line distribution of information on service components which are operable to act as components for building high-level services in a network;
a service simulation and testing section for providing functions relating to verification of service products;
a service deployment section for deploying services in the telecommunication network;
a service assurance section for monitoring and reporting of the service products; and
a usage reporting section for processing reports on the service products' performance and usage.
